(19) United States
(12) Patent Application Publication
(10) Pub. No.: US 2012/0029986 A1
(43) Pub. Date: Feb. 2, 2012

(54) SYSTEM AND METHOD FOR IMPROVING E-COMMERCE

(76) Inventor: Reza Jalili, Sandy, UT (US)

(21) Appl. No.: 13/253,070

(22) Filed: Oct. 5, 2011

Related U.S. Application Data
(63) Continuation of application No. 12/764,906, filed on Apr. 21, 2010.
(60) Provisional application No. 61/444,949, filed on Feb. 21, 2011.
(60) Provisional application No. 61/172,222, filed on Apr. 24, 2009.
(60) Provisional application No. 61/257,837, filed on Nov. 3, 2009.

(51) Int. Cl. G06Q 30/02

(52) U.S. Cl. 705/14.13; 705/14.73

(57) ABSTRACT

A system and method for improving advertising response rates by allowing an electronic advertising content to be stored, retrieved, shared, and manipulated by individual users, while enabling the accurate recordation of accounting information associated with the electronic advertising content.

### CLAIM OF PRIORITY

This application is a continuation-in-part of provisional application No. 61/444,949, filed Feb. 21, 2011, which is a continuation of U.S. patent application Ser. No. 12/764, 906, filed Apr. 21, 2010, which claims priority benefit under 35 U.S.C. §119(e) from U.S. provisional application No. 61/172,222, filed Apr. 24, 2009 and provisional application No. 61/257,837, filed Nov. 3, 2009. Each of these applications is incorporated by reference herein, in their entireties, for all purposes.

### FIELD

The present invention generally pertains to processing electronic advertising content and/or other media on an electronic network in order to improve electronic commerce.

### BACKGROUND

Advertising on the Internet involves placing an electronic advertisement, herein referred to as an “electronic ad,” on a Web page or with other digital content in the hope that a consumer will see it. Advertising on the Internet involves an enormous market that has been growing steadily since 1995. Massive sums of money have been spent on advertising on the Internet, including tracking the performance of electronic ads and targeting advertisements to particular audiences using technologies referred to as “targeting technologies.” Yet of all the electronic ads distributed on Web sites, only a very few are clicked. Ad space providers and advertisers perpetually grapple with the problem of low response rates.

An electronic ad includes electronic advertising content and this content is distinct from other forms of electronic content distributed via the Internet. Electronic advertising content is created by a commercial entity in order to drive usage and/or sales of a good or service, herein collectively referred to as “product.” It is not merely content associated with a product, but rather is distributed specifically to generate a benefit (typically a monetary one) for the producer or supplier of the product. For example, an independent review of a product is not electronic advertising content, whereas advertising text distributed by the manufacturer is electronic advertising content. Additionally, electronic advertising content is subject to advertising laws and regulations, such as truth-in-advertising laws.

An electronic ad may be created so that its distribution may be tracked and evaluated. For example, an electronic ad may include computer code that enables an advertiser to ascertain how many times it has been viewed (e.g., how many “impressions” or “clicks”). Electronic ad tracking may be conducted for financial purposes. For example, an ad provider may charge for ad distribution on a per-view basis. An advertiser may be responsible for paying the ad provider a fee each time the ad is viewed or for a particular amount of viewings.

Generally, electronic advertising works in the following way: a Web site publisher designates space on its Web site as available for advertising. An ad provider provides the publisher with a computer code to be implanted in this ad space. An ad provider is an entity, such as Google AdSense, Yahoo, or the like, that distributes electronic ads via a network (e.g., the Internet) on behalf of an advertiser, usually for a fee. An advertiser is an entity wishing to promote a good, service, or the like. When an individual visits a particular page of the publisher's Web site via his web browser, the page is generated per the publisher's source code, while the electronic ad is generated in the ad space per the ad provider's code. The electronic advertising content is retrieved from the ad provider's ad server and fills the ad space on the Web page. The ad server maintains electronic advertising content, typically configured by the ad provider on behalf of an advertiser. Each time a visitor visits a Web page, a new set of electronic ads may be displayed because the site publisher may have business relationships with more than one ad provider or because the same ad provider may choose a different set of electronic ads to show on the Web page. Furthermore, the electronic ad code itself may specify various ads to be shown in the ad space and the ad displayed may vary per the user's particular visit to the Web page. A user may select an electronic ad, such as by clicking it, and his web browser typically is directed to present a landing page associated with the advertiser. The landing page is typically the advertiser's main Web page or a Web page detailing a particular offer. For example, a user selecting an electronic ad for a dating service will be presented with the dating service's home page. When a user clicks on an electronic ad, his attention to his previous task is interrupted. With the web browser navigating to the ad's landing page, the user's attention is diverted.

What is needed is a mechanism to improve advertising response rates. Furthermore, what is needed is a system and method for improving advertising response rates while enabling accurate tracking of electronic ads and thereby enabling accurate accounting procedures. Furthermore, what is needed is a way to allow a user to indicate interest in an electronic ad without having to disrupt his current task, whether that is reading an article, watching a video, or searching for an answer.

Due to the particularities of electronic advertising content, it may be difficult to store electronic ads for future viewing, sharing, or the like. A user cannot simply bookmark or save a Web page and assume that the next time he accesses the Web page the electronic advertising content will be the same. The site publisher may change its ads periodically and electronic ads may be dynamic and, therefore, inherently storage prohibitive. For example, an electronic ad may involve JavaScript which is executed on the user's web browser. The JavaScript code accesses the ad server in real-time to retrieve the computer code needed to render an ad on the user's browser. This form of electronic ad cannot be extracted from the web browser. In fact, the ad code is specifically designed to be safe and hidden from other code executed on the same browser and on the same Web page. This level of security makes it difficult to extract the visual and informational content of the ad automatically for storage and later retrieval or sharing. A user may cut-and-paste the electronic ad from the browser into another document, but that action is time consuming and error-prone. For example, the copied ad may contain code that only functions properly when the user's web browser is at the appropriate Web site. When an ad is cut-and-pasted from the user's web browser, and the user attempts to view it later, the user's computer may not be able to employ the extracted ad code accurately. In some cases, a cut-and-paste operation also will not copy certain ad server access codes or identification codes that may be used by the ad server to keep track of the ad for accounting and billing purposes, thereby interfering with accurate tracking of the electronic ad.

For at least the aforementioned reasons, electronic advertising content does not inherently lend itself for storage and sharing by individual Internet users.

What is needed is to have a system and method for providing individuals with a seamless mechanism for storing an electronic ad for viewing at a future time and providing a mechanism to accomplish the later viewing.

### SUMMARY

The present invention addresses the aforementioned needs by providing a system and method for enabling the accurate recordation of accounting information associated with an electronic advertising content, where the electronic advertising content may be stored, retrieved, shared, and manipulated by individual users.

### BRIEF DESCRIPTION OF THE DRAWINGS

In order to describe the manner in which the above-recited and other advantages and features of the invention may be obtained, a more particular description of the invention briefly described above will be rendered by reference to specific embodiments thereof that are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a general architecture overview of an embodiment of a personal advertisement storage system;

FIG. 2 illustrates an embodiment of a personal advertisement storage system server;

FIG. 3 illustrates a flowchart of an embodiment of a process for accessing a stored electronic advertisement from an ad server;

FIG. 4 illustrates a flowchart of an embodiment of a process for accessing a stored electronic advertisement from an ad server via a personal advertisement storage system server;

FIG. 5 illustrates a flowchart of an embodiment of a process for accessing a stored electronic advertisement from a personal advertisement storage system server;

FIG. 6 illustrates a flowchart of an embodiment of a process for storing an electronic advertisement at a personal advertisement storage system server; and

FIG. 7 illustrates a flowchart of an embodiment of a process for storing an electronic advertisement via an ad server.

### DESCRIPTION

Various embodiments of the invention are discussed in detail below. While specific implementations are discussed, it should be understood that this is done for illustration purposes only. A person with ordinary skill in the relevant art will recognize that other components and configurations may be used without departing from the spirit and scope of the invention.

The present invention is described herein mainly in terms of an individual accessing the Internet, such as via a personal computer, a mobile phone, a personal electronic assistant, or a multipurpose mobile device (e.g., an iPhone, a Blackberry, etc.). This is not to be construed as limiting as the present invention may be applicable to any electronic network accessible to a user via a network-appropriate device. For example, the present invention may be applied to broadcast networks (e.g., cable, satellite, etc.), mobile networks, interactive television systems, kiosk systems, and any technologies that enable the electronic display of advertisements.

Personal Advertisement Storage System (PASS)

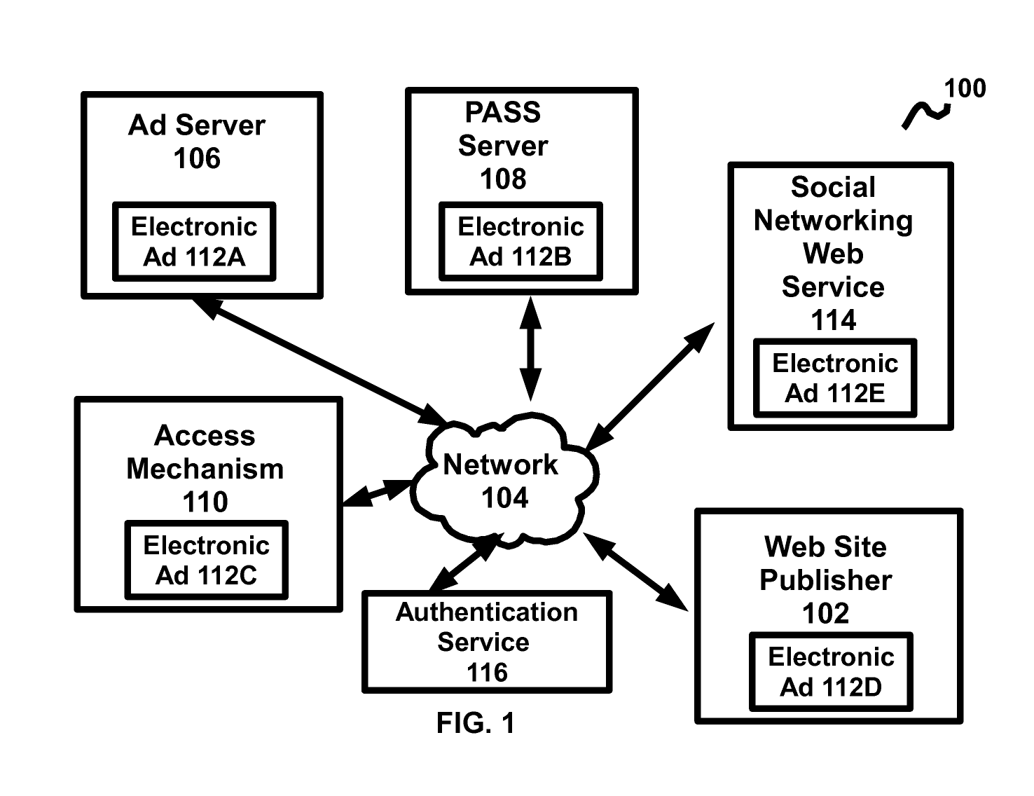

As illustrated by FIG. 1, the present invention pertains to personal advertisement storage system (PASS) 100. Although only a single instance of each component is depicted, this is for illustrative purposes only and is not to be construed as limiting. Furthermore, although each component is depicted and described herein as separate, this is not to be construed as limiting, and components may be combined per implementation. For example, PASS server 108 and ad server 106 may be combined into one component and/or be maintained by the same entity or affiliated entities. PASS 100 may include one or more ad servers 106, PASS servers 108, and Web site publishers 102. Ad server 106 may be maintained by an ad entity, which may be an organization or individual that distributes electronic ads and its ad server 106 may maintain its electronic advertising content. An ad entity may be an ad provider (e.g., Google AdSense), an advertising agency, an individual advertiser, a newspaper (e.g., with classified ads), or the like. For example, PASS server 108 may interact with several, disparate ad servers 106, such as servers run by Google, Yahoo, Microsoft, and AOL. PASS 100 may also comprise one or more social networking Web services 114 (e.g., Facebook, Twitter, Google+, etc.) and/or one or more authentication services 116. A user may interact with PASS 100 via access mechanism 110 and access mechanism 110 may enable the user to access data from ad server 106 or PASS server 108. Access mechanism 110 may be a combination of software and hardware configured to enable the viewing and the inputting of information by the user. For example, a user may access

PASS 100 by loading a Web page on his personal computer via a web browser, such as Microsoft Internet Explorer or Mozilla Firefox, or through his mobile device via its browsing application. Additionally, a user may access PASS 100 via other properly equipped devices, such as televisions, kiosks, or other presentation systems. Furthermore, PASS 100 may be accessible via various embodiments of access mechanism 110 and a user may employ any combination of these. For example, a user may store an electronic ad via his mobile phone and later access it via his television. The components of PASS 100 may interact with one another via network 104, which may be an applicable electronic network, such as the Internet or a mobile network.

The term “electronic ad” is not to be construed as limiting and may pertain to electronic data associated with an advertisement in various forms as would be appropriate to the related system component. For example, in relation to ad server 106, PASS server 108, Web site publisher 102, or social networking Web service 114, an electronic ad (e.g., electronic ad 112A, electronic ad 112B, electronic ad 112D, and electronic ad 112E, respectively) may pertain to a data record and/or computer code. In relation to access mechanism 110, an electronic ad (e.g., electronic ad 112C) may pertain to a visual representation of an advertisement along with other data, such as a link. An electronic ad may include a video, an image, textual data, or any other advertising medium. An electronic ad may include data indicative of a particular item for sale, such as an item offered at eBay.com, Amazon.com, or the like.

### PASS Link

To participate in PASS 100, an ad entity may embed a PASS link in an electronic ad when creating it (i.e., electronic ad 112A). The PASS link may encode information about electronic ad 112A and the URL of PASS Server 108. An ad entity may also modify existing ads to include a PASS link. The PASS link may be configured to be display a PASS icon in proximity to the actual electronic advertising content. Alternatively, the PASS link may be embedded into the electronic ad so that no icon is necessary and the ad may respond accordingly when selected by a user. The PASS link may be computer code, such as JavaScript code, an HTML link, or similar mechanism, to instruct access mechanism 110 to perform a certain set of operations other than, or in addition to, what may be construed as a click-through. Once an electronic ad includes a PASS link, it may be considered “PASS-enabled” and may enable the electronic ad to be stored with minimal manual human action. In one scenario, a PASS-enabled electronic ad may enable a user to enter a keyword to store and/or access one or more electronic ads, as described in detail below. In another scenario, also described below, a PASS-enabled electronic ad may enable a user to store and/or access an electronic ad via social networking Web service 114. In one embodiment, as will be described below, a PASS-enabled electronic ad enables the electronic advertising content to be associated with the user at ad server 106 instead of, or in addition to, be stored in association with user at PASS server 108.

After the inclusion of a PASS link in electronic ad 112A, electronic ad 112A is enabled for storage if a user so chooses and may be distributed via standard methods. For example, when accessing a Web page, access mechanism 110 may display electronic ad 112A as electronic ad 112C by requesting the necessary data from ad server 106 and formatting it accordingly. In an alternative implementation, access mechanism 110 may retrieve the ad data via PASS server 108 (i.e., from electronic ad 112B). For example, the ad request may be sent directly to PASS server 108 instead of to ad server 106. PASS server 108 may retrieve the electronic ad 112A from ad server 106, configure it via configuration mechanism 214 to include the necessary PASS link information and, optionally, other user interface elements, and then distribute the PASS-enabled electronic ad 112B to access mechanism 110, which may display it as electronic ad 112C. Because PASS server 108 may carry out the embedding of PASS link, this implementation may necessitate no additional effort on the part of an ad entity. In another embodiment, Web site publisher 102 may configure a Web page to enable the inclusion of a PASS link in an electronic ad 112D it displays. For example, Web publisher 102 may enable the ad slots of its Web page to configure displayed electronic ads 112D as PASS-enabled electronic ads automatically by way of configuring its ad slots to capture the electronic ad served by ad server 106 and to provide user-interface elements within the ad slot or elsewhere to allow for the transmission and storage of the electronic ad; that is, to allow for PASS link information to be associated with the electronic ad served into the ad slot by ad server 106. In another embodiment, access mechanism 110 may be enabled to embed a PASS link in an electronic ad it displays (i.e., electronic ad 112C). For example, access mechanism 110 may detect the presence of one or more ad slots on a Web page it is presenting and may be configured to display the associated electronic ads 112C as PASS-enabled electronic ads automatically. In one embodiment, access mechanism 110 may be enabled to configure electronic ads 112C as PASS-enabled via a browser extension or “add-on.”

### Stored Electronic Ad

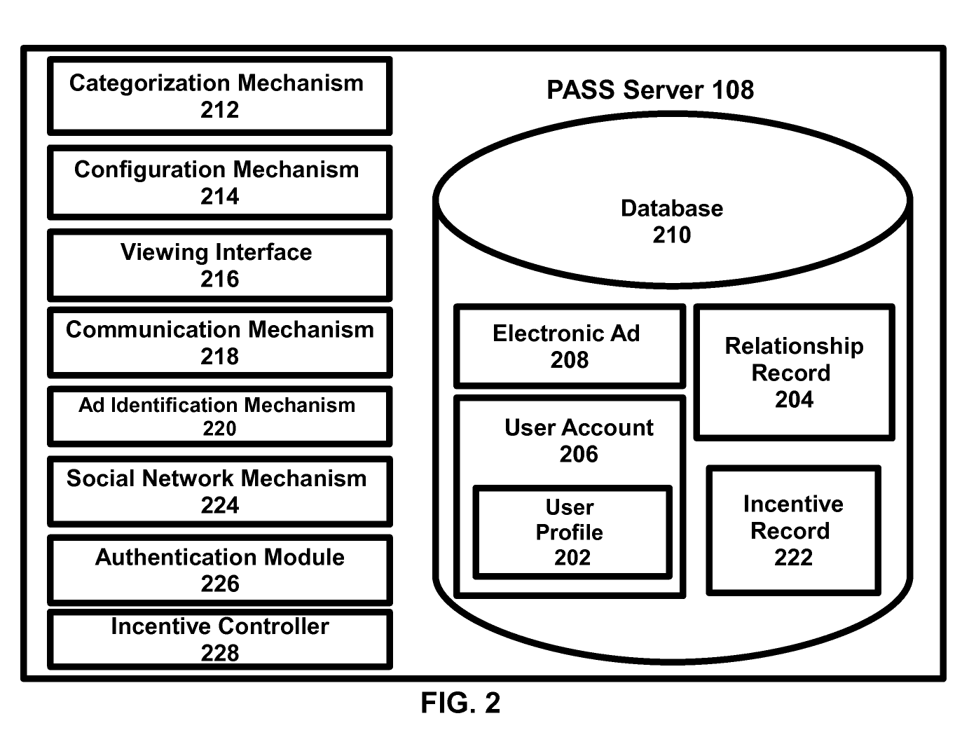

As illustrated by FIG. 2, PASS server 108 may include one or more databases 210 that securely maintain electronic ads 208 stored by users so that these ads may be accessed at a later time. Although the disclosed subject matter is described in terms of storing electronic ads via a server (i.e., PASS server 108), this is not to be construed as limiting and it is to be understood that any other suitable mechanism may be employed. Storing an electronic ad may involve storing data related to the ad in database 210 in such a way that a user may view stored electronic ad 208 as it was originally presented. For example, if an electronic ad includes a video involving a product offer, the user may store this electronic ad and later view the video when accessing the stored ad. PASS server 108 may transmit ad usage data to ad server 106 so that it may determine how many times stored electronic ad 208 has been viewed. A user's use of an electronic ad is described as “viewing,” but this is not to be construed as limiting. “Viewing” of an electronic ad as used herein pertains to an ad impression, a user selecting on the electronic ad, or the like.

In one embodiment, stored electronic ad 208 may include one or more of tracking information associated with the electronic ad, such as the referral location (e.g., information about the Web site at which the user viewed the electronic ad and/or information about the landing page accessed once an electronic ad is selected) and its Uniform Resource Location (URL). For example, stored electronic ad 208 may include the URL of a landing page accessed by selecting the electronic ad and may also include the URL for the electronic advertising content itself (e.g., an ad creative). In order to avoid possible formatting and display problems, the entire code associated with the electronic ad may be retrieved from ad server 106 and included with stored electronic ad 208. One or more elements of the stored electronic ad data, such as the URL, may be used as an identification reference to assist PASS server 108 and/or ad server 106 in locating the appropriate electronic advertising content.

In another embodiment, stored electronic ad 208 need not include one or more of the aforementioned elements. When PASS server 108 receives an indication that a user wishes to store an electronic ad, ad identification mechanism 220 may establish an ad identifier for the ad and this ad identifier may be included with stored electronic ad 208. For example, ad identification mechanism 220 may assign it an alphanumeric identifier. By assigning an ad identifier, PASS server 108 need not store all information associated with the electronic ad, some of which may be proprietary to the ad entity. The ad identifier may serve as an identification reference. Not storing the entire electronic ad information may reduce the burden of PASS server 108 and may allow ad server 106 to maintain complete control over the ad entity's electronic ads. In one scenario, stored electronic ad 208 only includes the ad identifier. Alternatively, the ad entity may generate an ad identifier for its electronic content. When publishing an electronic ad, the ad entity may assign it an ad identifier, include it in an embedded PASS link, and publish the ad identifier in association with the electronic ad. The ad identifier may be transmitted to PASS server 108 when the user indicates he wishes to store the associated electronic ad (e.g., by selecting the PASS icon). In an alternative embodiment, the ad entity may register an ad identifier with PASS server 108 when it publishes an electronic ad so that PASS server 108 may maintain a searchable registry of storable electronic ads.

In one embodiment, PASS 100 may be configured to interact with or include an electronic advertisement storage and searching system, such as the one described in application No. 12/952,111, filed Nov. 22, 2010, entitled “System and Method for Improving E-Commerce with On-Demand Advertising,” which is incorporated by reference herein, in its entirety, for all purposes. For example, PASS 100 may include a registry accessible to disparate ad entities to allow for the registration of their electronic ads and allow users to search the electronic ads maintained at an associated server.

If an ad identifier, rather than the complete ad code, is employed for storage, one or more processes may be employed by PASS server 108 to present stored electronic ad 208 via access mechanism 110. An ad identifier may serve as a reference for ad retrieval data within PASS server 108. Once a particular stored ad is selected for viewing, the PASS server 108 may locate ad retrieval data, such as a computer code, associated with its ad identifier. In one embodiment, PASS server 108 may share the ad identifier with ad server 106 so that ad server 106 may associate it with the appropriate ad in its own records. This may assist in determining the appropriate electronic advertising content at ad server 106 when user wishes to view stored electronic ad 208.

Content associated with stored electronic ad 208 may change subsequent to its storage. For example, stored electronic ad 208 may reference a landing page via a URL and content associated with the URL may change subsequent to the storage of electronic ad 208. PASS server 108 may transmit an instruction to access mechanism 110 to prompt a user to indicate a storage preference at the time of storage regarding whether he wishes to store only the current content of electronic ad, only the most recent content of an electronic ad (i.e., subsequent content), and/or both. Additionally, or alternatively, a user may set a storage preference in his user account 206 and need not be prompted. Furthermore, PASS server 108 may periodically (e.g., on a set schedule) query ad server 106 to determine if content associated with stored electronic ad 208 has changed and, if so, may notify the user of the change. For example, PASS server 108 may send an email regarding a change or may notify the user when he accesses his PASS account. PASS server 108 may determine whether content associated with stored electronic ad 208 has changed by examining the content. It may analyze one or more elements of the electronic advertising content to determine, for example, if the associated ad creative has changed. Rather than, or in addition to, analyzing the electronic advertising content, PASS server 108 may use a checksum to determine whether content has changed. Alternatively, ad server 106 may be configured to notify PASS server 108 of a change to content associated with stored electronic ad 208.

Particular electronic ads may be very popular and many users may store the same electronic ad. Doing so may encumber the processing and/or storage capabilities of PASS server 108. For example, if PASS server 108 is configured to allow an electronic ad to be stored multiple times in database 210, each of the duplicated entries may have its own ranking, rating, commenting, or the like. Although PASS server 108 may be configured to store an individual occurrence of each electronic ad each time one is stored, in one embodiment PASS server 108 may be enabled to reduce and/or eliminate the storage of duplicative electronic ads. PASS server 108 may be configured to store a single entry (or limited number) of an electronic ad and may reference this entry whenever a user requests to view it.

As mentioned, PASS server 108 may store tracking information associated with an electronic ad, such as the referral location (e.g., the URL of a Web page associated with the electronic ad) and the URL of the electronic ad itself. When PASS server 108 receives an indication that a user wishes to store an electronic ad, ad identification mechanism 220 may compare the electronic ad's tracking information with the electronic ad tracking information of electronic ads already stored in database 210. If the tracking information already has been stored, ad identification mechanism 220 may associate this previously stored data with the user's user account rather than create a separate entry of the same electronic ad. In this fashion, PASS server 108 may associate the same stored electronic ad 208 with different user accounts.

If PASS server 108 is configured to assign an ad identifier to stored electronic ads 208 as previously described, it may associate the same ad identifier with a particular electronic ad each time it is stored, rather than assigning a different ad identifier to each instance of storage. For example, when a user indicates an electronic ad is to be stored, ad identification mechanism 220 may analyze the electronic ad data stored within PASS server 108 and determine if the electronic ad has already be stored. If so and the electronic ad already has been assigned ad identifier, rather than assigning the same electronic ad a new ad identifier, ad identification mechanism 220 may associate the existing ad identifier with the user's account. As such, the same ad identifier may be associated with multiple user accounts. In one scenario, if PASS server 108 is configured to store enough electronic ad data so that ad server 106 need not be accessed to display the stored electronic ad 208, ad identification mechanism 220 may still assign stored electronic ad 208 an ad identifier. Ad identification mechanism 220 may reference assigned ad identifiers, instead of, or in addition to tracking information, to ensure that PASS server 108 does not store electronic advertising content redundantly.

As described herein, unless explicitly noted, a stored electronic ad may pertain to any of the aforementioned embodiments.

### User Data

Database 210 may also maintain a user account 206 for each user. Although electronic ads are described herein as being stored in user account 206, this is not to be construed as limiting. In one embodiment, rather than being stored in a particular user account 206, an electronic ad may be maintained separately at PASS server 108, but may be associated with user account 206 via a user identifier or similar mechanism. For example, electronic ads may be associated with an individual's email address, username, identification code, telephone number, or the like. User account 206 also may include user profile 202 which may include credential information (e.g., username and password), personal information, demographic data, financial account data, or the like. Database 210 may also maintain relationship record 204 which may include data pertaining to how particular users and ad entities are related to other users and ad entities. For example, relationship record 204 may indicate which users an individual has listed as friends or which users have stored ads for a particular ad entity. PASS server 108 may also include communication mechanism 218 which may enable PASS server 108 to interact with other entities via network 104, such as ad server 106 and access mechanism 110. PASS server 108 may, in addition to, or instead of a relationship record 204, include social network mechanism 224, thereby enabling interaction with a social networking Web service 114, such as Facebook. One or more elements of relationship information and user profile data may be stored in association with the user's social network account in addition to, or instead of, being associated with user account 206 at PASS server 108. For example, social network mechanism 224 may an application programming interface (API).

### Electronic Ad Storing

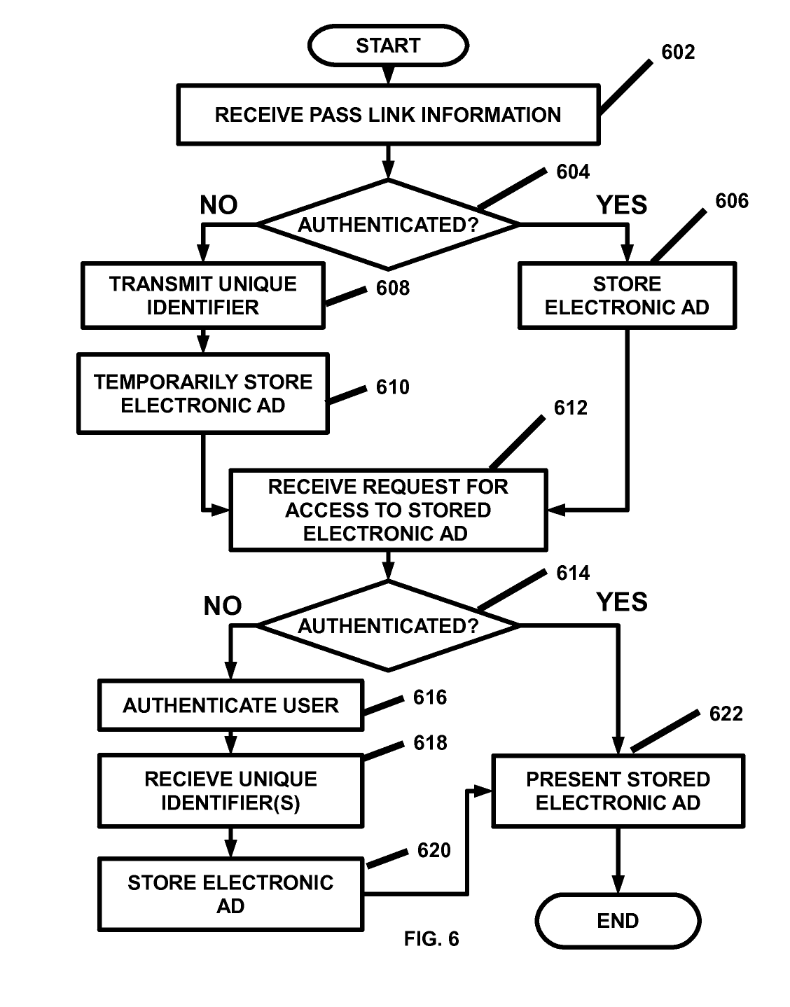

FIG. 6 illustrates a flowchart of an embodiment of a process for storing an electronic ad at PASS 108. As a user interacts with a Web page via access mechanism 110, he may be presented with a PASS-enabled electronic ad. If the user wishes to save the electronic ad for later viewing, he may select it, such as by clicking a PASS icon with a mouse if access mechanism 110 is a personal computer, by using a finger gesture (e.g., a finger swipe) if access mechanism 110 is a touchscreen device, or the like. In one scenario, rather than being a particular region of the ad or an icon, the PASS link may be embedded into the electronic ad in such a way that the user may store the electronic ad simply by selecting it (e.g., clicking it). The electronic ad may respond in a typical fashion (e.g., by instructing the web browser to present an ad-related landing page) or the electronic ad may be stored and the user may continue to interact with the current Web page. In an alternate embodiment, when the electronic ad is selected, an electronic form may become visible (e.g., overlaid on the electronic ad), presenting the user with two options: go to the ad landing page or store the electronic ad such that there is no further distraction from the current activity of the user. For example, when a user sees an electronic ad on a Web site, he may move his mouse pointer over the ad and an overlay may be shown on the ad with a prompt stating “go there now” and another prompt stating “save for later.” The user may select “save for later,” and JavaScript code associated with the PASS-enabled electronic ad may be executed by access mechanism 110, causing a message to be sent to PASS server 108 with encoded ad information. In another scenario, when a user selects the PASS-enabled ad, access mechanism 110 may present his user account to enable him to view stored ads, as detailed below.

Once a PASS-enabled electronic ad has been selected for storage, PASS server 108 may receive a storage instruction from access mechanism 110, including PASS link information (e.g., the URL and encoded ad information and/or the ad identifier) (step 602). Authentication module 226 may determine if the user has been authenticated (step 604). If so, authentication module 226 analyzes the user's credentials in order to associate the electronic ad with the appropriate user account 206, thereby storing it (step 606). Any known method may be employed to authenticate the user and identify his user account 206. For example, a user's credentials may be a tracking cookie, a username and password, a telephone number, a mobile device identifier [e.g., an electronic serial number (ESN), a mobile identification number (MIN), a subscriber identity module (SIM) code, etc.] or the like. In one embodiment, if the user has not been authenticated, he may be prompted to do so upon initiating electronic ad storage. Alternatively, as depicted in FIG. 6, to avoid burdening the user with authentication processes at the time of storage, PASS server 108 may transmit a unique identifier to access mechanism 110, such as a cookie or similar mechanism (step 608). PASS server 108 may then store the received PASS link information temporarily in association with the unique identifier (step 610).

As aforementioned, when a user opts to store an electronic ad, ad identification mechanism 220 may associate an ad identifier with the stored electronic ad 208. Ad identification mechanism 208 may generate the ad identifier or, if an ad identifier was included with the received PASS link information, ad identification mechanism 208 may use it. In one embodiment, PASS server 108 may communicate the ad identifier to ad server 106, which may in turn associate the ad identifier with the electronic ad in its own database. This may be unnecessary if the ad entity has already associated an ad identifier with the electronic ad.

When PASS server 108 subsequently receives a request for access to the stored electronic ad 208 from access mechanism 110 (step 612), authentication module 226 may again determine if the user has been authenticated (step 614). If so, the stored electronic ad 208 may be presented (step 622). If the user has not been authenticated, authentication module 226 may prompt the user for authentication credentials and the user may be authenticated (step 616). PASS server 108 may then receive one or more unique identifiers previously provided to access mechanism 110 (step 618), store the associated electronic ads 208 in association with the appropriate user account 206 (step 620), and present the stored electronic ad 208 (step 622). Alternatively, rather than requiring the user to ever actively authenticate himself, PASS server 108 may utilize the unique identifiers received from access mechanism 110 completely for the storage, retrieval, and presentation of a stored electronic ad 208.

In another embodiment, PASS 100 may include authentication service 116 and authentication service 116 may authenticate users on behalf of PASS server 108, rather than PASS server 108 itself. In one embodiment, a user may store an electronic ad in association with one or more of his PASS user account 206 and his social network Web service 114 account by way of social network mechanism 224. Social network Web service 114 may handle user authentication instead of, or in addition to, PASS server 108 or authentication service 114. In one embodiment, PASS server 108 interfaces with Facebook, Google, and/or other popular social networks, such that for the majority of users for the majority of the time, no prompting of user credentials is necessary when the user is already logged into one of those other services using access mechanism 110.

Selecting a PASS-enabled electronic ad may associate the electronic ad with the user's social networking Web service account. Alternatively, or additionally, electronic advertising content presented via social networking Web service 114 may be stored to PASS server 108. In one embodiment, PASS server 108 and social networking Web service 114 may interact with one another via a social network application (“app”). For example, a user may access Facebook and install a PASS app for his Facebook account. When the user “likes” electronic advertising content while accessing Facebook, the content may be associated with his PASS user account. Similarly, if a user selects a PASS-enabled electronic ad outside of Facebook, it may be stored and/or accessible via the Facebook app.

In one scenario, a software application may ease use of PASS 100. A web browser “add-on,” a Web service, a smartphone app, or the like may enable functionality that eases the storage of and access to electronic ads. The software application may allow a user to store or view one or more electronic ads associated with the appropriate user account 206. If the software application is associated with a web browsing application, the electronic ads still may be shown as the user browses the Web or they may be suppressed until the user accesses PASS server 108 (through the application or otherwise) to view them. The software application may enable cloud-based computing. For example, the software application may synchronize with data stored in the user account 206. The software application may store a user's credentials and preference information, thereby enabling automatic user authentication and seamless interaction with PASS server 108. For example, the software application may provide the user's credentials to PASS server 108, authentication service 114, or social network Web service 114.

### Electronic Ad Sharing

PASS 100 may also enable various viral marketing methods, such as the sharing of stored electronic ads. A user may be enabled to share stored electronic ad 208 with other individuals. This may be done through PASS server 108 (i.e., from one PASS user to another) or PASS server 108 may interact with another service, such as social networking Web service 114 (e.g., Facebook.com, MySpace.com, etc.), so that a user may share stored electronic ad 208 with other users of social networking Web service 114. As aforementioned, social network mechanism 224 may enable PASS server 108, and in turn the user, to view, store, and share electronic ads via a social networking Web service 114. In one embodiment, PASS server 108 itself may serve as a social networking Web service and users may see which stored electronic ads 208 other users have shared. Alternatively, a user may be enabled to share stored electronic ad 208 via email, such as by emailing a link to the stored ad. A user may be required to have authorization by another user to be privy to shared electronic ads. For example, an individual's shared, stored electronic ads 208 may only be visible to other users the individual has indicated are friends. To encourage users to share stored electronic ads 208, an ad entity or the PASS service provider may compensate a user for sharing. A user may be required to share a minimum amount before being compensated and/or a user may be limited to sharing a maximum number for a particular period (e.g., 100 ads per month). Once a user has shared stored electronic ad 208, it may be associated with both the initial user and the recipient. A first user who shares an ad that is subsequently deleted by a recipient second user may get negative points, which, when accumulated, may indicate that the first user is abusing the sharing mechanism and should be blocked or have her ability to share ads limited. This feedback mechanism may be important to reduce the spam effect.

### Viewing and Managing Stored Electronic Ads

After an electronic ad has been stored in association with user account 206, the user may access PASS server 108 to view it. A user may access electronic ads he has stored via various access mechanisms 110. For example, a user may access PASS server 108 via a mobile device to view electronic ads that he stored while using a personal computer. An electronic ad may be considered stored in (i.e., associated with) an individual's user account 206 if the individual stored it, if another PASS user shared it with the individual, or if the individual's profile settings allow PASS server 108 to store the electronic ad in his user account 206 automatically. Viewing interface 216 may present to the user stored electronic ads regardless of who stored the ad or may present only electronic ads stored by a certain set of users. For example, thumbnail images representative of stored electronic ads may be presented. While a user may have a personal set of stored electronic ads (e.g., those he has stored or those he has received via sharing), he may also be able to access the stored electronic ads of other users. A user may be allowed to designate which of his stored electronic ads are public and which are private.

The user may access PASS server 108 in various manners. For example, a user may access PASS server 108 by accessing a Web site, using a keyboard combination, by right clicking on a PASS-enabled electronic ad, thereby accessing a menu with a link to access PASS server 108, via his social networking Web service account, or the like. As aforementioned, in one scenario the user may access PASS server 108 by selecting a PASS-enabled ad to store it.

In one embodiment, a user may access a stored electronic ad by entering a keyword, which may be a word, a number, code, or the like. A PASS-enabled ad may include an input into which the user may enter the keyword. Once the keyword is entered, the user may be presented with the electronic ad via PASS server 108, ad server 106, and/or social networking Web service 114. Alternatively, or additionally, a user may be presented with a keyword input when he attempts to access his stored electronic ads. In another scenario, the user may be enabled to enter a keyword via a web browser add-on, such as toolbar. A keyword may be associated with a particular electronic ad, may be associated with all ads associated with a particular ad entity, or may be associated with all ads of a particular type. For example, entering a keyword may present the user with a selection of relevant electronic ads from multiple advertising entities or only the electronic ads from a particular advertising entity. An advertising entity may obtain the right to use a particular keyword from the PASS service provider. For example, Budweiser may purchase the rights to “beer” and may inform consumers that they need only enter “beer” to access any of Budweiser's electronic ads via PASS 100.

Once PASS server 108 is accessed, the user may provide credentials to log in. Alternatively, a user need not identify himself to view electronic ads stored publicly. When accessing PASS server 108, the user may be redirected to a PASS Web site or the user may remain at his current Web site and view the stored electronic ads 208 in an existing ad slot at the current Web page, on a pop-up screen, as an overlay on the current Web page, or the like. As aforementioned, PASS server 108 may interact with social networking Web service 114 and, as such, a user may be enabled to view, share, and manage stored electronic ads 208 via an interface at social networking Web service 114. Stored electronic ads 208 may be presented in the order in which they were stored, for example, displaying the first stored ad at the top or bottom of a list. In one implementation, participating ad entities may affect the presentation order of stored electronic ads 208. For example, an ad provider or advertiser may compensate the PASS service provider in order to have its ad presented advantageously. Additionally, the user may be enabled to sort his stored electronic ads 208 as he wishes, such as by date saved, title, or the like.

The user may select a stored electronic ad 208 to view it. Selecting a stored electronic ad 208 may load the ad per the stored data. The user need not log into or have access to the Web page where the ad was originally displayed as pertinent information and/or an ad identifier has been recorded at PASS server 108. The particulars of presenting a stored electronic ad 208 may vary per implementation. The viewing of a stored electronic ad 208 may be similar to the initial viewing of the electronic ad 112D at a Web page. When a user views a Web page, Web site publisher 102 may request the electronic advertising content (e.g., electronic ad 112A) from ad server 106 and may present it in an appropriate space on the Web page (i.e., an “ad slot”). In one scenario, the requested advertising content may be communicated through PASS server 108, such as if the content has not been PASS-enabled by ad server 106, so that it may be PASS-enabled by PASS server 108. When a user accesses PASS server 108 to view a stored electronic ad 208, PASS server 108 may serve as a publisher and present the stored electronic ad in a similar fashion, such as by requesting electronic advertising content from ad server 106.

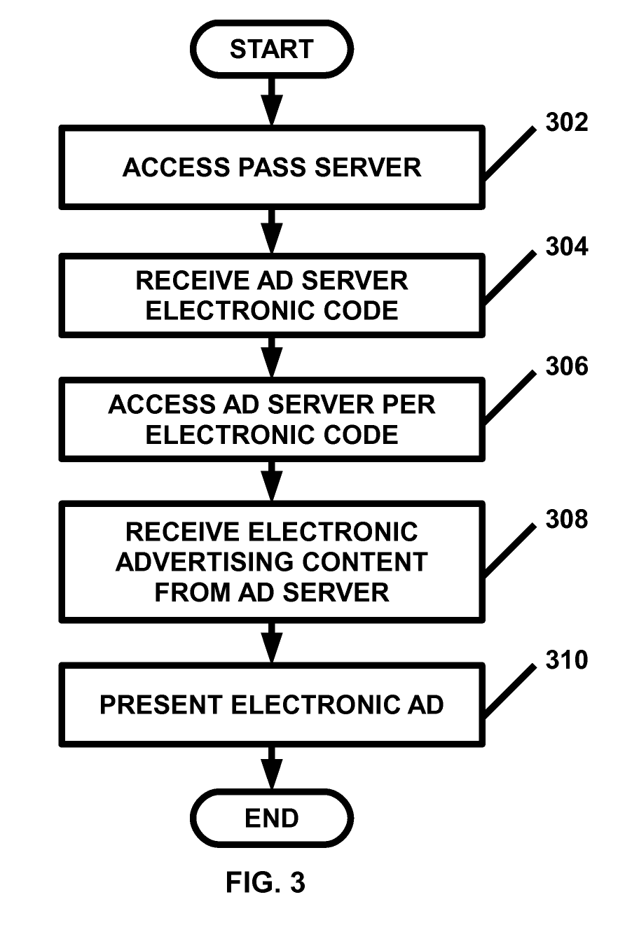

As illustrated by FIG. 3, in one embodiment, the user may employ access mechanism 110 to access PASS server 108 to view a stored electronic ad 208 (step 302). From PASS server 108, access mechanism 110 may receive computer code which may include the original ad server ad code (or code sufficiently similar) (step 304) and may employ it to access the ad server 106 (step 306). Access mechanism 110 may then receive the appropriate electronic advertising content from ad server 106 (step 308) and present the electronic ad to the user (step 310). In one scenario, PASS server 108 may provide access mechanism 110 with the same ad code used at the Web page from which the user stored the electronic ad 208, thereby functioning in a fashion similar to the originating Web page. For example, the retrieved computer code may indicate the stored electronic ad is provided by the Google ad server and the user's web browser may access the Google ad server to retrieve it. An ad identifier previously assigned to the stored electronic ad 208 by PASS server 108 may be used to assist with this process. The computer code provided to access mechanism 110 by PASS server 108 may include the ad identifier and access mechanism 110 may communicate this to ad server 106 so that ad server 106 may employ it to locate the appropriate electronic advertising content in its records.

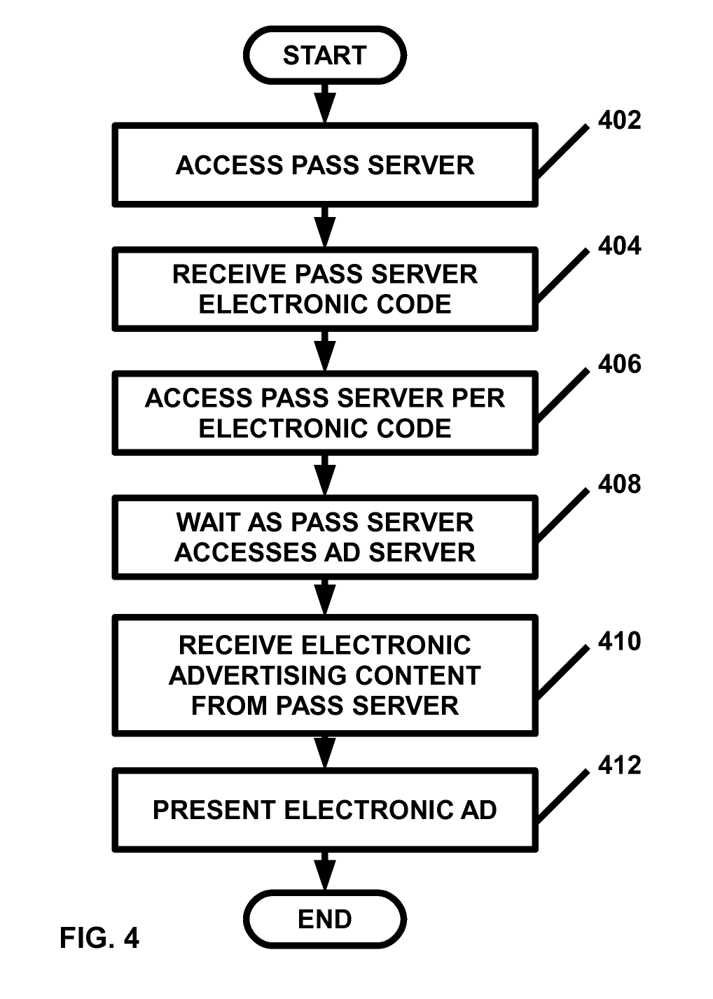

As illustrated by FIG. 4, in another embodiment, when access mechanism 110 accesses PASS server 108 (step 402), it may receive computer code that instructs access mechanism 110 to access PASS server 108 itself (step 404). When access mechanism 110 accesses PASS server 108 per this code (step 406), it may wait as PASS server 108 accesses ad server 106 to retrieve the electronic advertising content (step 408). Once PASS server 108 has retrieved the necessary content, access mechanism 110 may receive it (step 410) and present the electronic ad to the user (step 412). For example, when access mechanism 110 accesses stored electronic ad 208, the received computer code (e.g., HTML snippet data) may include a link (e.g., a URL) to PASS server 108, rather than ad server 106, and PASS server 108 may employ the computer code to determine the proper ad server 106 from which to receive the electronic ad. An ad identifier may assist with this process as well. For example, the computer code sent to access mechanism 110 from PASS server 108 may include an ad identifier and PASS server 108 may employ this to determine the proper ad server 106. In one embodiment, if ad server 106 has also associated the ad identifier with the electronic ad in its own records, PASS server 108 may communicate the ad identifier to ad server 106 in order to assist in the retrieval of the necessary electronic advertising content. In one scenario, PASS server 108 transmits only the ad identifier to ad server 106 for electronic ad retrieval. Because the electronic advertising content passes through PASS server 108, PASS server 108 may be enabled to modify the stored electronic ad.

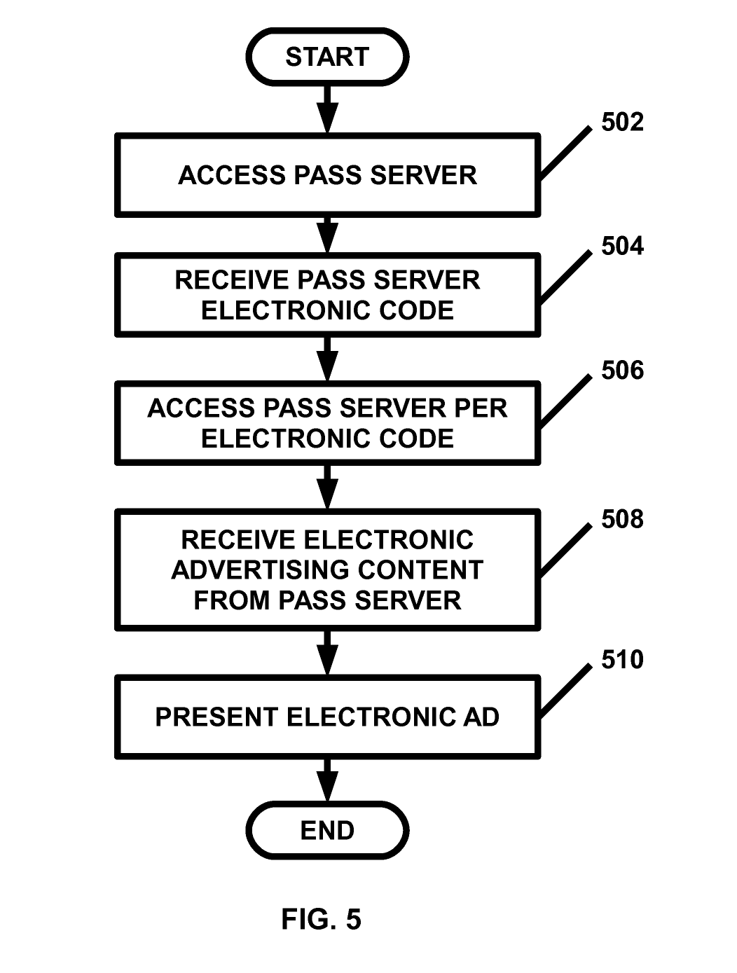

As illustrated by FIG. 5, in another embodiment, if stored electronic ad 208 includes all the necessary electronic advertising content, ad server 106 need not be accessed by access mechanism 110 or PASS server 108. When access mechanism 110 accesses PASS server 108 (step 502), it may receive computer code that instructs access mechanism 110 to access PASS server 108 itself (step 504). An ad identifier may be used to assist in locating the proper stored electronic ad. When access mechanism 110 accesses PASS server 108 per this code (step 506), access mechanism 110 may receive the electronic advertising content (step 508) and present the electronic ad to the user (step 510). For example, PASS server 108 may pre-generate the code (e.g., HTML) so that access mechanism 110 may display the electronic ad based solely on the rendering instructions PASS server 108 provides.

Stored electronic ads may be optimized upon presentation to increase overall advertising effectiveness. As aforementioned, because the request to view stored electronic ad 208 involves PASS server 108, PASS server 108 may be enabled to modify the stored electronic ad 208 when it is displayed. Ads from one advertising entity or from a set of advertising entities may be optimized such that each ad is more attractive to the user or a group of ads together are more attractive to the user. The advertising entity need not rely on ad server 106 to enhance stored electronic ad 208. For example, if the user has stored an ad for a chair and an ad for a table, PASS server 108 may retrieve and display a bonus ad for a set of dishes, a table cloth, or a discount for buying both the table and the chairs. PASS server 108 may display such ad combinations even if the ads are from different advertising entities. An advertising entity associated with an electronic ad may pay the PASS service provider a fee so that an additional electronic ad is presented whenever a particular electronic ad is presented. If a second advertising entity is paying for this service, the second advertising entity may request to have its electronic ad presented more prominently than the ad of the first advertising entity.

Ads stored via the PASS server 108 may be associated with one or more categories. For example, an electronic ad for beer may be categorized as “beer,” “drink,” and/or “alcohol.” When a user accesses his user account 206, his stored ads may be grouped by category. Ad categorization may be handled by the ad entity, the user, a PASS service provider, categorization mechanism 212, or a combination thereof. For example, an ad entity may associate data with an ad that indicates one or more proper PASS categories. The user may log into his user account 206 and categorize his stored ads as he wishes. For example, a user may “tag” a stored beer ad as “funny” or “beer.” Categorization mechanism 212 may categorize ads based on information provided by ad entities and/or users, or it may analyze ad content and categorize electronic ads appropriately.

### Electronic Ad Storing and Viewing via an Ad Server

In one embodiment, when a PASS-enabled electronic ad is displayed via access mechanism 110, data may be communicated through ad server 106. By communicating such data through ad sever 106, ad server 106 may log which electronic ads have been stored at PASS server 108 in addition to recording whether an electronic ad has been viewed.

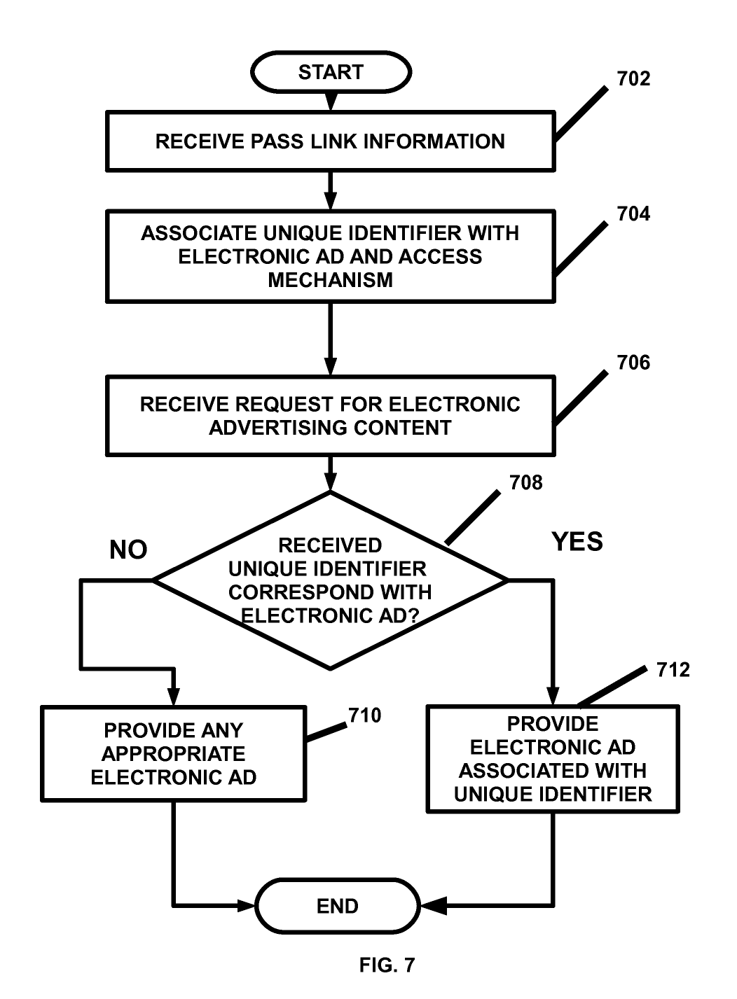

As depicted by FIG. 7, a PASS-enabled electronic ad may be configured to associate an electronic ad with the user at ad server 106 instead of, or in addition to, storing it at PASS server 108. In such an embodiment, a PASS-enabled electronic ad may be associated with access mechanism 110 at ad server 106 via the use of a unique identifier (e.g., a cookie). A user may employ access mechanism 110 to view a Web page maintained by Web site publisher 102 and Web site publisher 102 may retrieve one or more electronic ads from ad server 106 to present to the user. When a user views a PASS-enabled electronic ad that he would like to view later, he may indicate this, and ad server 106 may receive PASS link information (step 702). After receiving PASS link information, ad server 106 may associate a unique identifier with access mechanism 110 and with the appropriate electronic advertising content in its own database, thereby associating the electronic ad with access mechanism 110 (step 704). Ad server 106 may associate the unique identifier with access mechanism 110 by transmitting the unique identifier to access mechanism 110 when the user indicates he wishes to view the electronic ad later or ad server 106 may employ a unique identifier already present at access mechanism 110. For example, ad server 106 may automatically transmit a tracking cookie to access mechanism 110 when it accesses a Web site containing its electronic ads, regardless of whether the user has opted to view an electronic ad later. An electronic ad associated with access mechanism 110 in this fashion may be presented to the user whenever access mechanism 110 accesses a Web site configured to display electronic ads from ad server 106, regardless of whether the Web site publisher 102 is the same as the Web site publisher 102 involved in the initial display of the electronic ad. When access mechanism 110 subsequently accesses a Web page, ad server 106 may receive a request for electronic advertising content from the Web site publisher 102 and this request may include one or more unique identifiers associated with access mechanism 110 (step 706). Ad server 106 may determine if a received unique identifier corresponds with a unique identifier associated with an electronic ad (step 708). If not, ad server 106 may provide any electronic ad deemed appropriate (step 710). If ad server 106 determines that an electronic ad is associated with access mechanism 110 via a unique identifier, it may provide the corresponding electronic ad (step 712). Ad server 106 may acquire data regarding which electronic ads interest the user in addition to increasing the chances that the user will view the electronic ad at one point.

In one scenario, a PASS-enabled electronic ad may provide the user with an interface so that he may specify when he would like to view the electronic ad. For example, a user may be presented with a drop down menu and he may select whether he wishes to view the electronic ad in an hour, a day, at specific date and/or time, or the like.

This particular electronic ad embodiment allows a user to indicate interest in an electronic ad and delay its viewing without the need to access PASS server 108. A user may indicate he would like to be reminded of an electronic ad at subsequent, more convenient time, and he need not take explicit action to view the electronic ad later. That is, he may be presented with the electronic ad when he subsequently accesses one of a plurality of Web sites and need not access PASS server 108 directly.

The aforementioned process need not involve PASS server 108 and therefore PASS server 108 may be omitted in such an implementation. In another embodiment, when ad server 108 receives an indication that user wishes to view an electronic ad later, in addition to associating a unique identifier with the electronic ad and access mechanism 110, ad server 106 may transmit the unique identifier to PASS server 108. PASS server 108 may store the unique identifier in a temporary record. If access mechanism 110 later accesses PASS server 108, PASS server 108 may obtain one or more unique identifiers from access mechanism 110, determine if it has stored any electronic ads in association with the received unique identifiers and store them in association the appropriate user account 206. PASS server 108 may store all of the necessary electronic advertising content or may store data sufficient to retrieve the electronic advertising content from ad server 106 (e.g., an ad identifier). As previously described, PASS server 108 may serve as the publisher and may present stored electronic ad 208 via access mechanism 110.

### Accounting for Electronic Ad Storage, Viewing, and Actions

PASS server 108 may interact with ad server 106, and any another authorized third-party, to enable proper tracking of stored electronic ads, click-through rate, and any associated payment (e.g., royalties, etc.). For example, PASS server 108 may share viewing data with the account manager of an ad agency or a third-party analytics server that charts and creates further statistics from the data. PASS server 108 may record each viewing of a stored electronic ad in a viewing log. This functionality may be enabled by an accounting mechanism, such as an API, to which any ad server 106 from a participating advertising serving network may connect. Electronic ads may operate via various budgeting schemes and, therefore, specific accounting processes may be necessary in order to ensure accurate accounting of an electronic ad stored and/or shared via PASS 100. The accounting process employed may be associated with the method of electronic ad storage and/or display. If the presentation of stored electronic ad 208 is handled in a fashion similar to an electronic ad displayed at a Web page (i.e., the electronic advertising content is retrieved from ad server 106), as illustrated by FIG. 3, ad server 106 may treat the viewing of stored electronic ad 208 in the same manner as an ad presented on a standard Web page. If all of the data necessary for displaying stored electronic ad 208 has been stored at PASS server 108, as discussed in relation to FIG. 5, access mechanism 110 may interface solely with PASS server 108 to display stored electronic ad 208, and therefore PASS server 108 may maintain a viewing log for stored electronic ad 208 and communicate this viewing data to ad server 106, instantly, periodically, or the like. If the display of stored electronic ad 208 requires PASS server 108 to serve as an intermediary between access mechanism 110 and ad sever 106, as depicted by FIG. 4, one or more of PASS server 108 and ad server 106 may track the viewing of stored electronic ads 208.

PASS server 108 may enable the analysis of stored electronic ads 208 in order to ascertain ad usage, such as viewings (e.g., “impressions,” “clicks,” etc.). In particular, PASS sever 108 may determine which electronic ads have been stored and/or shared but have not yet been viewed by the associated user(s). As such, PASS server 108 may provide an ad entity with data indicative of pending ad viewings. The ad entity may employ this data to determine how much interest there is in a particular electronic ad and whether his current budget for the electronic ad is sufficient. Unlike current processes, the analysis of unviewed electronic ads provides an ad entity with concrete data reflective of how many individuals are interested in viewing its electronic ads. For example, if an ad entity has allotted for 200 viewings of a particular electronic ad and ad server 106 indicates that the electronic ad has been viewed 95 times total (via PASS 100 and perhaps other sources), and the analysis of PASS server 108 indicates that its database 210 has 150 potential viewings of the electronic ad, the ad entity may ascertain that its budget might be exceeded by at least 45 viewings. The ad entity may then take appropriate action, such as by increasing its budget for that electronic ad. If the ad entity does not wish to increase its budget to match demand, the ad might be removed from ad server 106 before certain users have had an opportunity to view it. In this case, a user may be notified that stored electronic ad 208 is no longer available. The user may be informed of this when he attempts to view stored electronic ad 208 and/or PASS server 108 may notify him via personal information held in his user account 206 (e.g., via an email sent to the user's registered email address).

### Incentives

Although a user may utilize PASS 100 simply for pleasure, he may also be encouraged to participate through various incentive methods, the particulars of which may be stored in one or more incentive records 222 maintained by PASS server 108. Incentive controller 228 may manage such incentives and track data pertaining to their use. In one embodiment, an incentive for the user may or may not be activated based upon actions he does or does not perform. The user may register one or more financial accounts in association with his user account 206 and may receive financial benefits. For example, an ad entity may compensate the user for displaying its electronic ad advantageously on his PASS display. Alternatively, an ad entity may compensate the user when the user accepts an ad entity's promotion, provides information to the ad entity, provides a recognized benefit to the ad entity, or the like. PASS 100 may facilitate immediate and scheduled transactions using information stored in user account 206 (e.g., financial information, personal information, and/or other information) and the user may be compensated by receiving a monetary payment into a registered financial account. Alternatively, the user may receive other benefits, such as a discount on an advertised product.

### Aggregate Information Analysis

PASS 100 may also enable the display and analysis of aggregate information. For example, PASS server 108 may display to users and/or ad entities aggregate statistics and information regarding electronic ads stored for various groups of users or for all users. Aggregate information may also be used to affect how stored electronic ads are displayed to users. For example, electronic ads may be displayed in order of popularity, such as by the number of users who have stored the ad or the number of viewings of an electronic ad. Additionally, PASS 100 may enable incentives based on group decisions (herein referred to as “group incentives”). An individual user may receive an incentive, such as a discount or other special benefit, dependent upon whether a certain number of other users performed one or more actions. Incentive controller 228 may associate a redemption code with the user's user account 206 once the user has performed the necessary action, thereby associating users that are participating in the group incentive. The redemption code may be included in data received when an electronic ad is stored or incentive controller 228 may generate the redemption code. In one scenario, a user need only store the electronic ad in order to participate in the group incentive and receive the redemption code. Alternatively, a user may indicate he desires to participate in a group incentive by selecting a previously stored electronic ad. Alternatively, a redemption code associated with a user account 206 may only be activated once the user has performed a more involved action (e.g., purchased the necessary product) in addition to storing the electronic ad. For example, if a stored electronic ad pertains to a chair and if 10,000 chairs are purchased, each user that has stored the relevant electronic ad may receive a 10% refund. The refund may be credited to a user's registered financial account. In such a scenario, a user may have to indicate to the retailer at the time of purchase that he is a PASS user, such as by providing his PASS username or a PASS membership number. The retailer may in turn communicate this information to PASS server 108, which may then determine if the redemption code is associated with the appropriate user account 206 and, if so, incentive controller 228 may activate the redemption code. Alternatively, the user may receive a completion code after performing the required action (e.g., on a sales receipt), may access his user account 206 and enter the completion code, thereby activating the redemption code. Group incentive data may be shared with external entities, such as ad entities, so that they may analyze it and determine the quantity of users that have the redemption code associated with their user accounts 206.

In one scenario, a user may request electronic ads from other PASS users or from participating ad entities. For example, the user may access a PASS Web page and enter a query into a search field to determine if any electronic ads stored within the PASS server 108 meet his criteria. For example, a user interested in leasing a vehicle may request ads that provide leasing discounts (e.g., the user may search for a “car lease discount”). The user may then be presented with a result set listing any relevant electronic ads that have been stored by users. PASS server 108 may also communicate the query to ad server 106 to determine if ad server 106 has any relevant ads stored within its records and, if so, PASS server 108 may retrieve the relevant ads and display them to the user. Due to the benefits of the ability to request ads, a user may be required to compensate the PASS service provider, other users (e.g., those who stored the requested ad), or ad entities (e.g., those who issued the requested ad). An ad entity or the PASS service provider may compensate a user for sharing ads.

### Passive Electronic Ad Storage

In an alternate embodiment, PASS 100 may function in a passive function and may automatically store electronic ads a user encounters while employing access mechanism 110. The PASS service provider may share this information with ad entities. In one scenario, automatic storage may be optional. A user may opt-in to the automatic electronic ad storing or may instead opt for active storage. PASS server 108 may store all PASS-enabled electronic ads a user encounters while browsing the Internet or while accessing his user account 206. Rather than requiring a user to interact with electronic ads, a PASS link may enable its associated electronic ad to be stored automatically. Alternatively, PASS server 108 may store all electronic ads (whether or not they are PASS-enabled) a user encounters while he is employing a PASS computer application. If the user encounters an electronic ad already stored at PASS server 108 (stored either by a user or registered by an ad entity), PASS server 108 may associate the electronic ad with the appropriate user account 206. For example, it may associate the electronic ad with the user account 206 via a cookie while browsing the Internet and/or may automatically associate the electronic ad with user account 206 after a user has logged in to view one or more stored or shared ads.

A user may access statistical data, such as how many electronic ads he has viewed daily, weekly, or the like. A user may be able to provide feedback regarding stored electronic ads 208, such as by indicating those he liked, those he did not, those that he found relevant, or the like.

### PASS Network Variations

As aforementioned, although the present invention has been described mainly in terms of Internet usage, this is not to be construed as limiting. For example, PASS 100 may be employed via an interactive television system, such as digital cable television system, an Internet television system (e.g., Google TV), or the like. The television programming may be content broadcast traditionally or may be programming available via Internet resources. A television ad presented during a commercial break may, for example, be presented with a PASS icon or may include an embedded PASS link. The user may employ his television remote select and store the ad to his user account 206. Without a PASS icon, another indicator or no indicator may be used. The user may later use the interactive television system to access his user account 206 and view the ad. In another scenario, electronic ads may be presented to the user while he watches the programming. For example, one or more ads may be overlaid over the programming, may be presented in a crawl adjacent to the programming, or the like. The user may be able to select one or more ads and these may be temporarily saved. Alternatively, rather than being temporarily saved, the electronic ads may be stored to his user account 206. When the user wishes to view the electronic ads (e.g., during a commercial break), he may retrieve a listing of the ads he has saved. He may then store one or more of the saved electronic ad to his user account 206, view the electronic ad, delete the electronic ad, or the like. In one scenario, the storage and viewing of electronic ads may be associated with the viewing of the television programming. For example, a user may not be allowed to view further programming until he has stored, temporarily saved, and/or viewed a minimum number of ads.

As aforementioned, PASS 100 may be implemented as or in conjunction with a mobile system. For example, a PASS icon may be displayed graphically with an advertisement or as text and the user may select the icon or text for storage of the electronic ad. If the PASS link is embedded within the ad, it may be stored simply if the user selects the ad, such as by performing a gesture on a touchscreen device. An electronic ad may have an audio indicator instead of or in addition to a visual icon. Voice commands may be used for interacting with the electronic ad. For example, the user may speak “save the ad” into a microphone to have the electronic ad stored to his user account 206.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention. Therefore, the description should not be considered to be exclusive of these other embodiments. Also, it is to be understood that the phraseology and terminology employed herein are for the purposes of description and should not be regarded as limiting.

1. A system for the storage and retrieval of electronic ads, the system comprising:
a storage server configured to:
store electronic ad data in association with one or more user accounts, wherein the stored electronic ad data enables viewing of an electronic ad distributed by an ad entity via an ad server;
receive a storage instruction from a user via an access mechanism, wherein the storage instruction indicates electronic ad data to be stored by the storage server and the electronic ad data to be stored is distributed by an ad entity via an ad server;
determine whether the electronic ad data to be stored is stored in association with the one or more user accounts, and
if the electronic ad data to be stored is associated with the one or more user accounts, associating the stored electronic ad data with a user account associated with the user, and
if the electronic ad data to be stored is not associated with the one or more user accounts, associating the electronic ad data distributed by the ad entity with the user account associated with the user, thereby storing the electronic ad data; and
present the stored electronic ad data to the user upon receiving a request from the user via the access mechanism to view the stored electronic ad data.

2. The system of claim 1, wherein the storage server is configured to assign an ad identifier to the stored electronic ad data.

3. The system of claim 1, wherein the storage server is configured to determine whether the electronic ad data to be stored is stored in association with the one or more user accounts by determining whether the electronic ad data to be stored includes an ad identifier or tracking information included in the stored electronic ad data.

4. The system of claim 1, wherein the storage server is configured to communicate with one or more of the access mechanism and the ad server.

5. The system of claim 1, wherein the storage server is configured to authenticate the user.

6. The system of claim 1, wherein the storage server is configured to distribute an incentive associated with the stored electronic ad data.

7. A method for storing an electronic ad to enable subsequent presentation of the electronic ad, the method comprising:
receiving, at an ad storage system from an access mechanism, a request to store electronic ad data in association with a user account, wherein the electronic ad data is maintained by an ad server and is identified by an identification reference;
transmitting, by the ad storage system to the access mechanism, an instruction to prompt a user employing the access mechanism to indicate a storage preference, wherein the storage preference indicates whether the user wishes to store one or more of current electronic ad data identified by the identification reference and subsequent electronic ad data identified by the identification reference;
receiving, at the ad storage system from the access mechanism, the storage preference of the user;
locating, by the ad storage system, a user account associated with the user; and
storing the electronic ad data in association with the user account per the received storage preference.

8. The method of claim 7, wherein the access mechanism is one of a personal computer, a mobile device, or a television.

9. The method of claim 7, wherein if the received storage preference indicates the user wishes to store subsequent electronic ad data identified by the identification reference, determining, by the ad storage system, whether the electronic ad data identified by the identification reference is different from the electronic ad data stored in association with the user account.

10. The method of claim 9, wherein determining comprises analyzing the electronic ad data maintained by the ad server and identified by the identification reference.

11. The method of claim 10, wherein analyzing the electronic ad data comprises determining if an ad creative has changed.

12. The method of claim 10, wherein analyzing the electronic ad data comprises a checksum.

13. A method for enabling the presentation of a stored electronic ad, the method comprising:
receiving, at an ad storage system from an access mechanism, a request to access an electronic ad stored via the ad storage system, wherein the request includes a keyword and wherein the electronic ad data is distributed by an ad entity via an ad server;
locating, by the ad storage system, electronic ad data associated with the keyword; and
transmitting, by the ad storage system to the access mechanism, the electronic ad data associated with the keyword, wherein the electronic ad data transmitted to the access mechanism enables the access mechanism to present the requested electronic ad.

14. The method of claim 13, wherein the keyword is associated with one or more electronic ads.

15. The method of claim 14, wherein the one or more electronic ads are associated with only one ad entity.

16. The method of claim 14, wherein the keyword is associated with one or more electronic ad categories.

17. The method of claim 13, wherein receiving, at the ad storage system from the access mechanism, the request to access an electronic ad stored via the ad storage system, wherein the request includes a keyword comprises receiving a keyword input by a user into an electronic ad enabled to receive a keyword from the user.

18. The method of claim 13, wherein receiving, at the ad storage system from the access mechanism, the request to access the electronic ad stored via the ad storage system, wherein the request includes a keyword comprises receiving a keyword input by a user into a keyword input displayed when the user accesses a user account maintained by the ad storage system.
